(19) United States
(12) Patent Application Publication
(10) Pub. No.: US 2025/0358676 A1
(43) Pub. Date: Nov. 20, 2025

(54) ACTIVE DISCARDING BASED ON PDU SET CORRELATION

(71) Applicant: InterDigital Patent Holdings, Inc., Wilmington, DE (US)

(72) Inventors: Rocco Di Girolamo, Laval (CA); Srinivas Gudumasu, Montreal (CA); Xavier De Foy, Kirkland (CA); Kevin Di Lallo, Laval (CA); Michael Starsinic, Newtown, PA (US); Magurawalage Chathura Madhusanka Sarathchandra, London (GB); Achref Methenni, Montreal (CA)

(73) Assignee: InterDigital Patent Holdings, Inc., Wilmington, DE (US)

(21) Appl. No.: 18/666,166

(22) Filed: May 16, 2024

(51) Int. Cl. H04W 28/06; H04W 28/02

(52) U.S. Cl. CPC H04W 28/06; H04W 28/0268

(57) ABSTRACT

A wireless transmit/receive unit (WTRU) or network node may perform active discarding based on PDU set correlation. A WTRU may receive a message from a network node, for example, indicating a rule, an active discarding/dropping indication, an active discarding option, a protocol data unit (PDU) set notification parameter, and/or a timing correlation parameter. The PDU set may be obtained. The WTRU may determine an age of the PDU set (e.g., duration of time) when it is determined that the PDU set is the reference PDU set. The WTRU may determine whether the PDU set is to be used or discarded, for example, based on the active discarding/dropping indication, the rule, the age of the PDU set, and/or a propagated PDU set dropping information. The WTRU may discard/drop the PDU set. The WTRU may send a notification message to a network entity.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems and methods are described herein for active discarding based on PDU set correlation. Active discarding based on PDU set correlation may be performed by a wireless transmit/receive unit (WTRU) or a network node (e.g., network entity).

A wireless transmit/receive unit (WTRU) or network node may perform actions associated with active discarding based on PDU set correlation. For example, a WTRU may receive a message from a network node (e.g., first network node). The message may indicate a rule, an active discarding/dropping indication, an active discarding option, a protocol data unit (PDU) set notification parameter, and/or a timing correlation parameter. The WTRU may determine that a PDU set is a reference PDU set (e.g., first PDU reference set) using the timing correlation parameter. The PDU set may be obtained (e.g., via a second WTRU, a second network node). The WTRU may determine an age of the PDU set (e.g., duration of time) when it is determined that the PDU set is the reference PDU set. The WTRU may determine whether the PDU set is to be used or discarded, for example, based on the active discarding/dropping indication, the rule, the age of the PDU set, and/or a propagated PDU set dropping information. The propagated PDU set dropping/discarding information may be received, for example, from the network node. The WTRU may discard/drop the PDU set, for example, if (e.g., when) it is determined that the PDU set is to be discarded/dropped. The WTRU may send a notification message to a network entity, for example, based on the rule and the PDU set notification parameter. The notification message may indicate that the PDU set has been discarded. The WTRU may send the PDU set to a second WTRU or a second network node, for example, if (e.g., when) it is determined that the PDU set is to be used. The PDU set may be associated with uplink or downlink data. The propagated PDU set dropping/discarding information may be associated with one or more sets that have been discarded by at least one of a second WTRU, the first network node, or a second network node. The actions performed by the WTRU may be performed by a network node (e.g., a network node may be configured to perform actions associated with active discarding based on PDU set correlation).

A first network node may receive a first message from a second network node. The first message may indicate a configuration associated with a session level report. The first network node may determine the session level report. Determining the session level report may be associated with receiving the session level report from at least one of the first WTRU, a second WTRU, the second network node, the third network node, or a fourth network node. The session level report may include one or more of the following: an information element (IE), an identification of a user plane element (UPE), or an identification of the discarded PDU set. The session level report may be associated with a discarded PDU set. The first network node may determine a WTRU, or a third network node impacted by the discarded PDU set, for example, using the configuration and the session level report. The first network node may send a second message to the WTRU or the third network node. The second message may indicate the discarded PDU set. The second message may include an information element.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example of QoS management.

FIG. 3 illustrates an example of communication and computing resources.

FIG. 4 illustrates an example of active discarding.

FIG. 5 illustrates an example of PDU Set drop information propagated to WTRU.

FIG. 6 illustrates an example of PDU Set Discarding based on timing correlation requirements.

### DETAILED DESCRIPTION

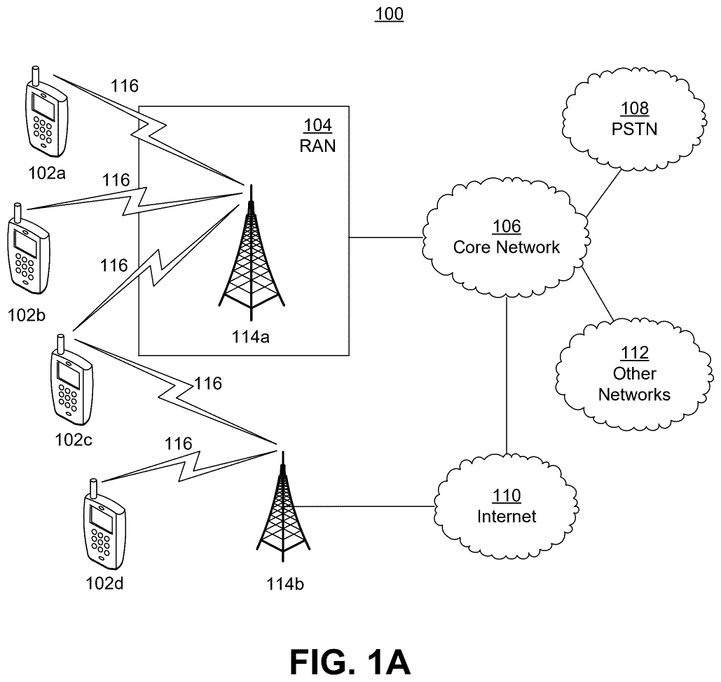

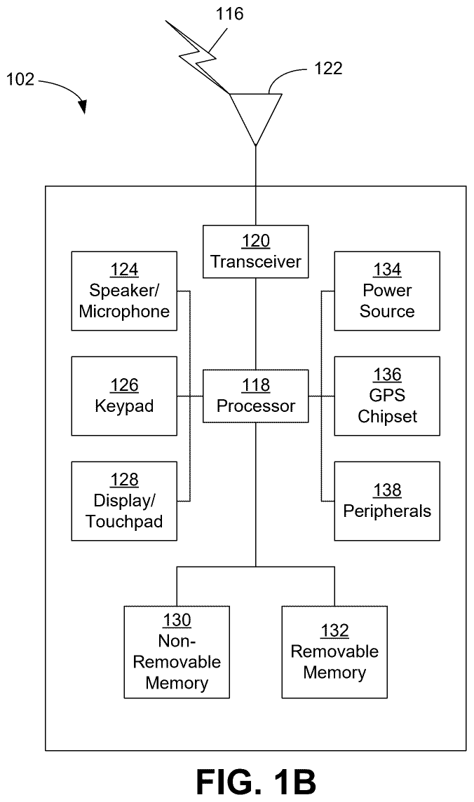

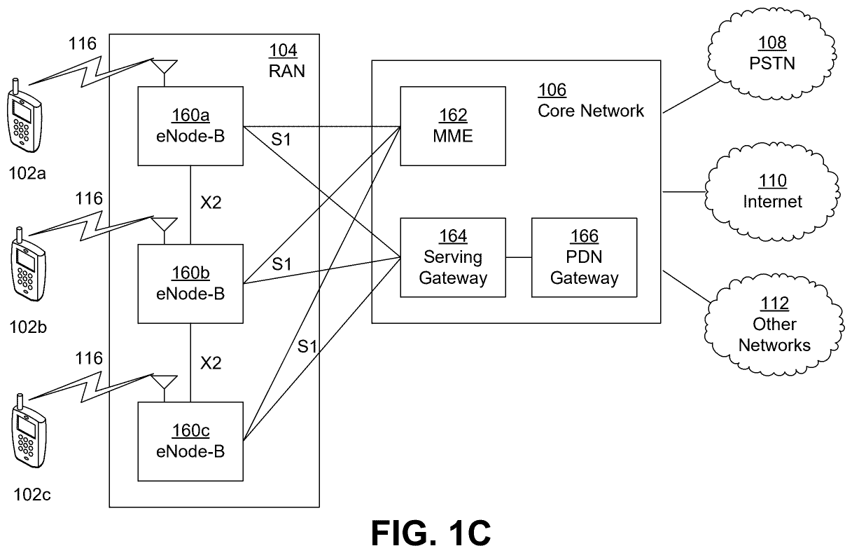

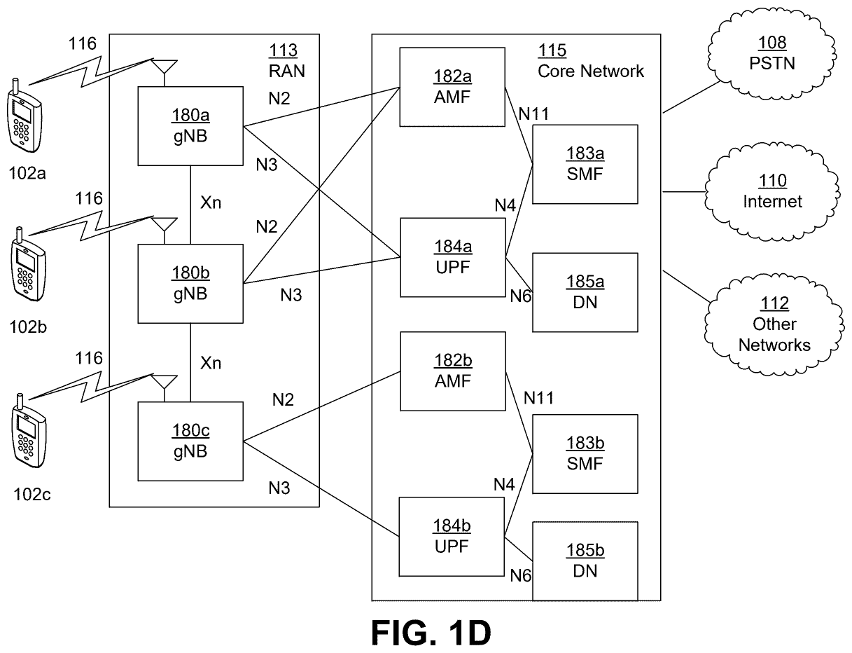

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c, and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B (eNB), a Home Node B, a Home eNode B, a gNode B (gNB), a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth© module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, one or more emulation devices may perform one or more, or all, functions while being fully or partially implemented and/or deployed as part of a wired and/or wireless communication network to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network to implement testing of one or more components. The one or more emulation devices may be testing equipment. Direct RF coupling and/or wireless communications via RF circuitry (e.g., which may include one or more antennas) may be used by the emulation devices to transmit and/or receive data.

Systems and methods are described herein for active discarding based on PDU set correlation. Active discarding based on PDU set correlation may be performed by a wireless transmit/receive unit (WTRU) or a network node (e.g., network entity).

A wireless transmit/receive unit (WTRU) or network node may perform actions associated with active discarding based on PDU set correlation. For example, a WTRU may receive a message from a network node (e.g., first network node). The message may indicate a rule, an active discarding/dropping indication, an active discarding option, a protocol data unit (PDU) set notification parameter, and/or a timing correlation parameter. The WTRU may determine that a PDU set is a reference PDU set (e.g., first PDU reference set) using the timing correlation parameter. The PDU set may be obtained (e.g., via a second WTRU, a second network node). The WTRU may determine an age of the PDU set (e.g., duration of time) when it is determined that the PDU set is the reference PDU set. The WTRU may determine whether the PDU set is to be used or discarded, for example, based on the active discarding/dropping indication, the rule, the age of the PDU set, and/or a propagated PDU set dropping information. The propagated PDU set dropping/discarding information may be received, for example, from the network node. The WTRU may discard/drop the PDU set, for example, if (e.g., when) it is determined that the PDU set is to be discarded/dropped. The WTRU may send a notification message to a network entity, for example, based on the rule and the PDU set notification parameter. The notification message may indicate that the PDU set has been discarded. The WTRU may send the PDU set to a second WTRU or a second network node, for example, if (e.g., when) it is determined that the PDU set is to be used. The PDU set may be associated with uplink or downlink data. The propagated PDU set dropping/discarding information may be associated with one or more sets that have been discarded by at least one of a second WTRU, the first network node, or a second network node. The actions performed by the WTRU may be performed by a network node (e.g., a network node may be configured to perform actions associated with active discarding based on PDU set correlation).

A first network node may receive a first message from a second network node. The first message may indicate a configuration associated with a session level report. The first network node may determine the session level report. Determining the session level report may be associated with receiving the session level report from at least one of the first WTRU, a second WTRU, the second network node, the third network node, or a fourth network node. The session level report may include one or more of the following: an information element (IE), an identification of a user plane element (UPE), or an identification of the discarded PDU set. The session level report may be associated with a discarded PDU set. The first network node may determine a WTRU, or a third network node impacted by the discarded PDU set, for example, using the configuration and the session level report. The first network node may send a second message to the WTRU or the third network node. The second message may indicate the discarded PDU set. The second message may include an information element.

Details associated with a User Plane Entity (UPE) are provided herein.

A WTRU or User Plane Entity (UPE) may receive rules from a network entity (e.g., SMF), for example, which may include one or more of the following: an indication whether active discarding is enabled for a stream; an indication if PDU set dropping/discarding notification is sent to SMF; and/or timing correlation parameters (e.g., requirements). A UPE (e.g., first UPE) may receive data (e.g., XR data) from another User Plane Entity (e.g., second UPE) or from the application server. User plane data may include a PDU set. A UPE may determine if a received PDU set is a reference PDU set, for example, if the UPE receives a timing correlation parameter (e.g., requirement). The UPE may track a duration (e.g., (re)starts a timer), for example, if the PDU set is determined to be a reference PDU set. The UPE may determine the age of the PDU set, for example, if it determines that the PDU set has a reference PDU set. The UPE may determine whether to discard the PDU set (e.g., if active discarding is enabled), for example, based on the received rules, propagated PDU set dropping/discarding information, and/or the age of the PDU set. The UPE may send the PDU set to another UPE (e.g., second UPE) or application server, for example, if the UPE determines that the PDU set should not be discarded. The UPE may discard the PDU set, for example, if it determines that PDU set should be discarded. The UPE may (e.g., if User Plane Entity drops or discards a PDU set) send a notification to SMF to indicate the dropped PDU set or discarded PDU set, for example, if notification is enabled based on received rules. A UPE may be a network node, for example, a node that may process user plane data such as one or more of the following: WTRU, UPF, RAN Node, etc. A UPE may drop a packet because of congestion at the UPE or because of an issue in the transport network between UPEs. Received user plane data may include uplink or downlink data. Propagated PDU set drop/discard information may include information received from SMF related to PDU sets that have been dropped/discarded by a UPE.

Details associated with a session management function (SMF) are provided herein.

A Session Management Function (SMF) may receive configuration information associated with (e.g., be configured to perform) receiving N4 Session Level Reports related to PDU set dropping and/or PDU set discarding. The SMF may receive session level reports (e.g., N4 Session Level Reports) from a UPE, for example, about a dropped/discarded PDU set. The SMF may determine UPEs impacted by the dropped/discarded PDU set. The SMF may provide an indication to impacted UPEs about the dropped/discarded PDU set, for example, where the indication may include a PDU set drop/discard IE. The session level report (e.g., N4 Session Level Report) may include one or more of the following in the PDU set drop/discard IE: ID of the UPE where the PDU set is dropped/discarded, ID of the dropped PDU set, ID of the discarded PDU set etc.

Details associated with QoS Management (e.g., in a 5G System) may be provided herein.

QoS management (e.g., in 5G systems) may be based on QoS flows. PDUs (e.g., all PDUs) in a QoS flow may receive the same treatment in the RAN and in the UPFs in the core network. The QoS Flow may be associated with QoS differentiation. The QoS flow may be a granularity (e.g., the finest granularity) of QoS differentiation in the PDU Session. A QoS flow may be associated with QoS parameters (e.g., requirements) such as one or more of the following: 5QI (e.g., including resource type, Priority Level, PDB, PER, Averaging Window, Maximum Data Burst Volume), ARP, RQA, Notification Control, Flow Bit Rates (e.g., MFBR, GBR), Aggregate Bit Rates, Maximum Packet Loss Rates, etc.

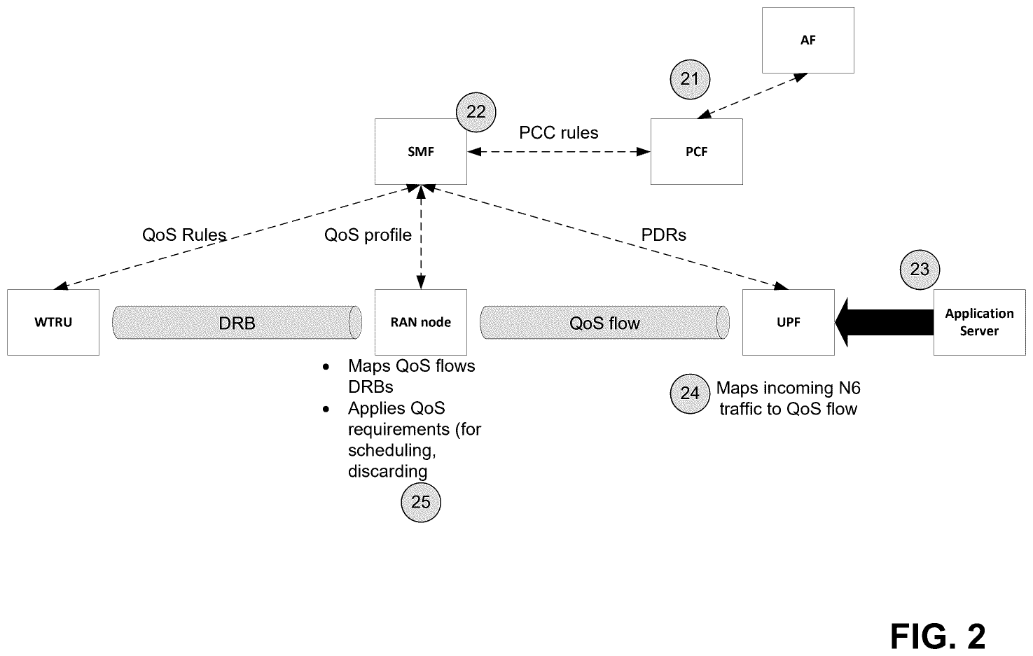

FIG. 2 illustrates an example of QoS management. FIG. 2 illustrates an example of enabling QoS management in the 5G system (5GS).

As shown at 21 in FIG. 2, an application function (AF) may provision the network (e.g., PCF) with QoS parameters (e.g., requirements) of the traffic flows (e.g., using a NEF service API such as Nnef_AFsessionWithQoS_Create).

As shown at 22 in FIG. 2, the QoS information may be used by the PCF to configure PCC rules. The SMF may configure a RAN node with a QoS profile, the UPF with PDRs, and/or the WTRU with QoS rules, for example, based on the rules configured in the PCF.

As shown at 23 in FIG. 2, the PDU may arrive at the UPF (e.g., over the N6 interface).

As shown at 24 in FIG. 2, the UPF may map the traffic to a QoS flow, for example, using the configured PDRs. The UPF may create a tunnel to the RAN node. The UPF may send the arriving PDU to the RAN node in a GTP-U packet.

As shown at 25 in FIG. 2, the RAN node may use the configured QoS profile to determine how to manage the GTP-U packet. This management may include how to schedule the packet to the WTRU and whether the packet may be dropped. If scheduled, the packet may be transmitted to the WTRU on a configured Data Radio Bearer (DRB).

Additional processing may be used (e.g., defined) for XR media traffic. XR traffic may be transmitted as PDU sets. The QoS profile may have parameters (e.g., requirements) that target PDU sets (e.g., PDU set QoS requirements). The header of the GTP-U PDU may carry PDU set information. This may allow the RAN node to provide a PDU set (e.g., based QoS handling), for example, active discarding of certain PDUs based on PDU Set Information and PDU set QoS parameters (e.g., requirements).

PDU Set based QoS handling may be supported.

To support PDU Set based QoS handling, the PSA UPF may identify PDUs that belong to PDU Sets and may determine PDU Set Information which the PSA UPF may send to the NG-RAN in the GTP-U header. The PDU Set information may be used by the NG-RAN for PDU Set based QoS handling.

The PDU Set Information may include one or more of the following: PDU Set Sequence Number; indication of End PDU of the PDU Set; PDU Sequence Number within a PDU Set; PDU Set Size in bytes; PDU Set Importance (e.g., which may identify the relative importance of a PDU Set compared to other PDU Sets within a QoS Flow).

The PSA UPF may rely on information carried in the received packets and/or on implementation, for example, to determine the PDU set information. For example, if the XRM traffic is carried over RTP, the RTP header may contain one or more of the following: end PDU of the PDU Set (E) (1 bit) (e.g., an indication/flag that may be set to 1 for the last PDU of the PDU Set and set to 0 for all other PDUs of the PDU Set); end of Data Burst (EDB) (3 bits) (e.g., the EDB field may be 3 bits in length and may indicate the end of a Data Burst, and where the 3 bits may encode the End of Data Burst indication); PDU Set Importance (PSI) (4 bits) (e.g., where the PDU Set Importance field may indicate the importance of this PDU Set compared to other PDU Sets within the same QoS flow, for example, where lower values may indicate a higher importance PDU Set with the highest importance PDU Set indicated by 0 and the lowest importance PDU Set indicated by 15; a PDU Set Sequence Number (PSSN) (10 bits) (e.g., the field may encode the sequence number of the PDU Set to which the current PDU belongs acting as a 10-bit numerical identifier for the PDU Set); PDU Sequence Number (PSN) within a PDU Set (6 bits) (e.g., where for the sequence number of the current PDU within the PDU Set, the PSN may be set to 0 for the first PDU in the PDU Set and incremented monotonically for every PDU in the PDU set in order of transmission from the sender); PDU Set Size (PSSize) (24 bits); etc.

The PDU Set Size may indicate the total size of PDUs (e.g., all PDUs) of the PDU Set to which this PDU belongs. This field may be optional and subject to an SDP signaling offer/answer negotiation, for example, where the Application Server may indicate whether it will be able to provide the size of the PDU Set for that RTP stream. If not enabled, the field may not be present. If enabled, but the Application Server is not able to determine the PDU Size for a particular PDU Set, the value may be set to 0 in PDUs (e.g., all PDUs) of that PDU Set. The PSSize may indicate the size of a PDU Set including RTP/UDP/IP header encapsulation overhead of its corresponding PDUs. The PSSize may be expressed in bytes.

The network may receive configuration information indicating (e.g., configured with) PDU set QoS requirements or information, for example, in addition to the PDU set information carried in the GTP-U header. This information may be defined per QoS flow. The PDU set QoS requirements may be the same for all PDU sets carried in a QoS flow (e.g., because the information may be defined per QoS flow). One or more of the following PDU set QoS requirements may be defined for XRM traffic flows: PDU Set Delay Budget (PSDB); PDU set error rate (PSER); PDU set integrated handling information (PSIHI); etc.

The PDU Set Delay Budget may define an upper bound for the delay that a PDU Set may experience for the transfer between the WTRU and the N6 termination point at the UPF (e.g., the duration between the reception time of the first PDU (e.g., at the N6 termination point for DL or the WTRU for UL) and the time when all PDUs of a PDU Set have been successfully received (e.g., at the WTRU for DL or N6 termination point for UL)).

The PDU Set Error Rate may define an upper bound for the rate of PDU Sets that have been processed by the sender of a link layer protocol (e.g., RLC in RAN of a 3GPP access) but that are not successfully delivered by the corresponding receiver to the upper layer (e.g., PDCP in RAN of a 3GPP access).

The PDU Set Integrated Handling Information may indicate whether PDUs (e.g., all PDUs) of the PDU Set are used (e.g., needed) for the usage of the PDU Set by the application layer on the receiver side.

An additional PDU set QoS parameter (e.g., requirement) may be considered, such as, for example, the PDU Set FEC Success Ratio. The PDU set FEC success ratio may include a percentage of PDUs that may be (e.g., need to be) delivered (e.g., successfully delivered) to WTRU in order to allow the WTRU to recover the entire PDU Set.

PDU set traffic characteristics may be provided by the core network to the NG-RAN, for example, to configure a WTRU power saving management scheme for connected mode DRX. The PDU set traffic characteristics may include one or more of the following: UL and/or DL Periodicity; N6 Jitter Information associated with the DL Periodicity; Indication of End of Data Burst; etc.

The UL and/or DL Periodicity and N6 Jitter Information associated with the DL Periodicity may be provided by the core network to NG RAN (e.g., via TSCAI). The core network may obtain this information from the AF, or it may derive some of these at the UPF. It may be transferred to the NG RAN, e.g., via the SMF and AMF.

PDU Set based QoS handling may be performed, for example, based on Active Discarding.

The WTRU and RAN node may be configured for PDU Set based QoS handling. If (e.g., when) the PSIHI indicates that PDUs (e.g., all PDUs) of the PDU Set are used (e.g., needed) for a QoS flow, as soon as one PDU of a PDU set is known to be dropped/discarded, the remaining PDUs of that PDU Set may be considered as no longer needed by the application and may be subject to discard operation at the transmitting entity to free up radio resources.

The WTRU may (e.g., in UL) be configured with PDU Set based discard operations (e.g., configuration information) for a specific Data Radio Bearer (DRB). The WTRU may discard packets (e.g., all packets) in a PDU set, for example, if (e.g., when) one PDU belonging to this PDU set is discarded due to discard timer expiry. In case of congestion, dedicated downlink signaling may be used to request the WTRU to apply a shorter discard timer to low importance PDU Sets in PDCP.

The RAN node may (e.g., in downlink) be configured with PDU Set based discard operations (e.g., configuration information). The RAN node may perform downlink PDU Set discarding, for example, based on implementation by taking one or more of PSDB, PSI, or PSIHI parameters into account. In case of congestion, the RAN node may use the PSI for PDU set discarding.

PDU set based QoS handling may be performed.

The RAN node may perform active discarding of PDUs based on an application layer FEC (AL-FEC) provided over a PDU set. For example, a case may be considered where a PDU set uses AL-FEC and needs (e.g., requires) 60% of PDUs to be received. Remaining PDUs of the PDU set, if (e.g., when) a RAN node has successfully transmitted >=60% of the PDUs in a PDU set, may be discarded, for example, freeing up network resources.

The RAN node may perform active discarding of PDUs, for example, based on the correlation between PDU sets. For example, consider an AS that encodes video using 15 frames per second (fps) with a Group of Picture (GOP) structure: I, P1, P2, P3, 1, . . . . A (e.g., each) frame may be encoded as its own PDU set from AS. In order to properly decode one of the P frames, the decoder may use (e.g., need) previously encoded I/P-frames for proper rendering. In this example, if the RAN node fails to transit the PDU set(s) carrying the I frame, the following 3 P frames may not be successfully rendered at the WTRU. Their transmission over the air may not be used (e.g., be useless). If the RAN node fails to transmit a P frame, the subsequent P frames that use (e.g., rely on) the lost P frame may not be used (e.g., may be useless). If the RAN node is aware that certain P frames may not be used (e.g., are useless), it may actively discard the PDU set(s) carrying these P frames. To enable this, (e.g., all) correlated PDU sets may be included in the same PDU set group and additional PDU Set Information may be provided for a (e.g., each) PDU set within this group (e.g., a PDU set correlation), for example, which may identify how this PDU set is related or dependent on other PDU Set within the same PDU set group. If a PDU set is dropped/discarded, then one or more PDU sets (e.g., all PDU sets) in the group that are correlated to this dropped/discarded PDU set may be actively discarded by the RAN node.

Active discarding may allow the network to avoid wasting communication and computing resources for PDUs that are not usable to the endpoints. Active discarding may include (e.g., rely on) the network determining which PDUs are not usable and performing discarding.

Discarding may be done at the RAN node for downlink transmissions and at the WTRU for uplink transmissions. A discarding decision may be based on one or more of the following: PSER, PSDB, PSIHI, reception of enough PDUs in a PDU set based on AL-FEC, and/or loss of anchor PDU set (in a PDU set group). For the loss of an anchor PDU set, the loss (e.g., due to congestion or retransmission timeout) may be determined at the RAN node for downlink transmissions and at the WTRU for uplink transmissions.

The current baseline solution for active discarding may be inefficient. This may result in the network wasting communication resources for transmission of PDUs (e.g., over the air interface and transport network) that are not usable to endpoints, as well as wasting compute resources for managing PDUs (e.g., at the WTRU, RAN nodes, and UPFs) that are not usable to endpoints.

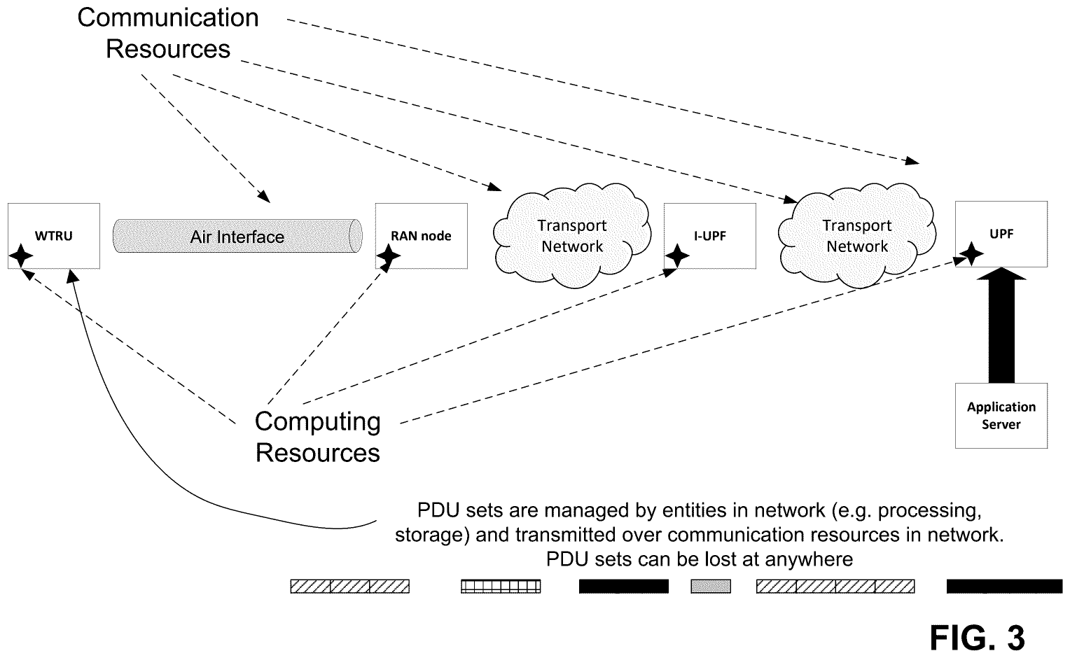

FIG. 3 illustrates an example of communication and computing resources. Waste of communication and computing resources in the network may be minimized. A first inefficiency may include that UL active discarding may be performed (e.g., only performed) at the WTRU, and DL active discarding may be performed (e.g., only performed) at the RAN nodes. The UPF may refrain from discarding (e.g., not discard) the PDU set, for example, if a UPF determines that a PDU set is not usable. The RAN node may refrain from discarding (e.g., not discard) the PDU set, for example, similarly, if a RAN node determines that an UL PDU set is not useable.

A second inefficiency may include that the RAN node may detect the loss of a downlink anchor PDU set and the WTRU may detect the loss of an uplink anchor PDU set. Other entities may be able to detect the loss of anchor PDU sets. If (e.g., when) these other entities detect the loss of an anchor PDU set, this information may not be propagated in the network. As a result, the RAN node and/or WTRU may not be able to take advantage of this information.

A third inefficiency may include (e.g., where it may be assumed) that a PDU set is not usable if it is determined that its PDU set anchor is dropped/discarded. However, other conditions may be considered (e.g., exist) to determine which PDU set may not be usable. For example, the PDU set may arrive too late with respect to a prior PDU set. As a result, these late-arriving PDU sets may consume communication and compute resources.

An anchor PDU set may refer to a PDU set that may be an anchor to a second PDU set. For an endpoint to properly use the second PDU set, the endpoint may receive (e.g., correctly receive) the anchor PDU set. For example, the anchor PDU set may represent an I-frame in a Group of Pictures. If the I-frame is not received at the endpoint, the P-frames that rely on this I-frame may not be used. If the I-Frame PDU set is dropped/discarded, the PDU sets representing the P-frames may not be useable at the endpoint. In some cases, the anchor PDU set may be (e.g., always) the first PDU set in a PDU set group.

A reference PDU set may refer to a PDU set that may be a timing reference to a second PDU set. For an endpoint to properly use the second PDU set, the endpoint may receive (e.g., correctly receive) the second PDU set within a certain time of the reference PDU set. For example, in a video stream, the endpoint may expect frames at a nominal frame rate. If a PDU set represents a frame, the PDU set may be worthless (e.g., not usable) if it arrives too late at the endpoint, where the time may be measured with respect to the prior PDU set arrival. In such a case, the reference PDU set may be the prior PDU set.

A PDU set that is not usable may refer to a PDU set which may not be used and/or necessary at an endpoint. For example, the PDU set may be a P frame, and the corresponding I frame may have been lost. As another example, the PDU set may arrive too late with respect to the arrival of a prior PDU set.

A User Plane Entity (UPE) may refer to any device or entity (e.g., network entity) that processes, receives, or sends user plane traffic. The user plane traffic may be uplink traffic from WTRU to an application server (e.g., or WTRU to WTRU), or downlink traffic from the application server to WTRU (e.g., or WTRU to WTRU). A UPE may be a WTRU, Radio Access Network (RAN) node, or User Plan Function (UPF).

Correlation Based PDU set Active Discarding (CB-PSAD) may refer to active discarding at a UPE, for example, which may be based on some correlation property between PDU sets. Examples of CB-PSAD may include one or more of the following: intra-stream anchor PDU set based correlation (e.g., correlation condition is checked within a stream, based on anchor PDU set); inter-stream anchor PDU set based correlation (e.g., correlation condition may be checked across two streams, based on anchor PDU set, for example, where the streams may be mapped to different QoS flows); intra-stream time-reference PDU set based correlation (e.g., correlation condition may be checked within a stream, based on time reference PDU set); inter-stream time-reference PDU set based correlation (e.g., correlation condition may be checked across two streams, based on time reference PDU set, for example, where the streams may be mapped to different QoS flows); PDU set drop/discard propagation (e.g., correlation condition may be based on propagating PDU set drop/discard information across a network (e.g., using a PDU set drop/discard message)); etc.

An application function (AF) may be used to help provision the network and may retrieve exposed information from the network, for example, in support of traffic from an application server. The AF and AS may be hosted on the same entity. In an example, the AF functionality may be included in the AS.

A PDU set discard may refer to PDU sets that are actively discarded by user plane entities (e.g., because they are not usable by the endpoints). A PDU set drop may refer to PDU sets that are lost either because of congestion at the user plane entities or in the transport network between the user plane entities. The network may not have control over PDU sets that are dropped. The network may disable or limit the PDU sets that are discarded.

Correlation based active discarding may be applied to PDU sets. In some cases, the PDU sets may include a single PDU. In such cases, the correlation based active discarding may apply across single PDUs.

PDU set age (e.g., age of a PDU set) may include where the CB-PSAD may use (e.g., rely on) a time-reference PDU set based correlation. The age of a PDU set may include the time difference between the PDU set and a prior PDU set.

One or more of the following may be used to manage and enable correlation based PDU set active discarding: provisioning and configuring the network to manage and enable correlation based PDU set active discarding; configuration and operations at PSA-UPF to mark PDU sets with new GTP-U header information to enable correlation based PDU set active discarding; configuration and operations at a WTRU to mark PDU sets with new GTP-U header information to enable correlation based PDU set active discarding; configuration and operations at user plane entities (e.g., WTRU, RAN nodes, UPFs) to determine if a PDU set may be actively discarded, based on the configuration; configuration and operations at user plane entities (e.g., WTRU, RAN nodes, UPFs) to propagate information about PDU set drops/discards; configuration and operations at an SMF to inform user plane entities (e.g., WTRU, RAN nodes, UPFs) about an anchor PDU set loss; etc.

Inefficiencies associated with active discarding may be minimized (e.g., optimized). This may enable the network to better utilize compute and storage resources at user plane entities, as well as communication resources between user plane entities.

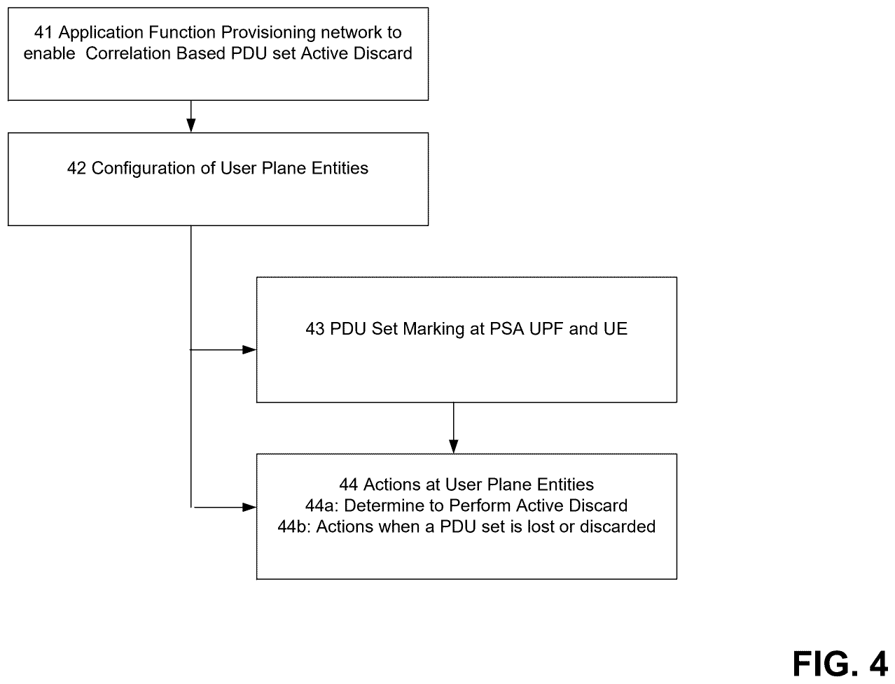

FIG. 4 illustrates an example of active discarding.

As shown at 41 in FIG. 4, the AF may provision the network with parameters and/or requirements to enable correlation based PDU set active discard.

As shown at 42 in FIG. 4, the SMF may configure the user plane entities. The configuration may include one or more of the following: configuration of WTRU and PSA UPF to enable marking of PDU sets with new PDU set information to support correlation based PDU set active discard; configuration of user plane entities to enable correlation based PDU set active discard; etc.

As shown at 43 in FIG. 4, the PSA UPF or WTRU may receive a PDU and may determine the PDU set information to include in the GTP-U header. This may include information to enable correlation based PDU set active discard.

As shown at 44 in FIG. 4, the user plane entities may actively discard PDU sets based on configuration information received and an active discard option. If (e.g., when) a PDU is dropped or discarded, the user plane entity may perform actions (e.g., as described herein).

Active Discard Options may be provided, configured, and/or performed.

Correlation information may be used by the user plane entities to make PDU set discard decisions.

Active discard options may be described, for example, to enable (e.g., allow) a user plane entity to make PDU set discard decisions based on correlation information.

In examples, a first active discard option may include that the PDU sets may be grouped into PDU set groups. A (e.g., each) PDU set group may be identified by a PDU Set group ID. A (e.g., each) PDU set group has a (e.g., single) anchor PDU set. For downlink traffic, the PSA UPF marks a (e.g., each) PDU set arriving over the interface (e.g., N6 interface) with the PDU Set group ID. The PSA UPF may mark the anchor PDU set in the group, for example, with the Anchor PDU Set indication. Similarly, for uplink traffic, the WTRU may mark a (e.g., each PDU set with the PDU Set group ID. The WTRU may mark the anchor PDU set in the group, for example, with the Anchor PDU Set indication. The user plane entities may actively discard the PDU sets (e.g., all the PDU sets) in the PDU set group (e.g., subsequently), for example, if a user plane entity determines that an anchor PDU set in a PDU set group is lost (e.g., due to congestion).

In examples, a second active discard option may include (e.g., for downlink traffic) the PSA UPF marking a (e.g., each) PDU set arriving over the interface (e.g., N6 interface) with the Anchor PDU set SN. The PSA UPF may mark a (e.g., each) anchor PDU set, for example, with the Anchor PDU Set indication. Similarly, for uplink traffic, the WTRU may mark a (e.g., each) PDU set with the Anchor PDU set SN. The WTRU may mark the anchor PDU set, for example, with the Anchor PDU Set indication. A (e.g., each) user plane entity may keep track of the PDU set sequence number associated with each anchor PDU set that is dropped and the stream ID for this PDU set. For a (e.g., every) PDU set, the user plane entity may verify if its Anchor PDU set SN matches the sequence number of the dropped anchor PDU set. If yes, the UPE may actively discard the PDU set.

In examples, a third active discard option may include (e.g., for downlink traffic), the PSA UPF marking a (e.g., each) PDU set arriving over the interface (e.g., N6 interface) with the Anchor PDU set SN. The PSA UPF may mark an (e.g., each) anchor PDU set, for example, with the Anchor PDU Set indication. Similarly (e.g., for uplink traffic), the WTRU may mark a (e.g., each) PDU set with the Anchor PDU set SN. The WTRU may mark the anchor PDU set, for example, with the Anchor PDU Set indication. The user plane entity (e.g., entities) may send a PDU set drop/discard message to the SMF indicating the stream ID and the PDU set SN of the dropped/discarded anchor PDU set, for example, based on dropping an anchor PDU set. The SMF may send the PDU set drop/discard message to the impacted user plane entities. The SMF may know the user plane entities that are transporting the stream. The message may include the stream ID and the PDU set SN of the dropped/discarded PDU set. The impacted user plane entity may cross-reference to determine the PDU sets that have this dropped/discarded PDU set as their anchor PDU set. Once determined, the user plane entity may actively discard these PDU sets.

In examples (e.g., an alternative to the third active discard option), the user plane entity may send a dummy user plane packet that provides an indication of the SN of the lost anchor PDU set as well as its stream ID, for example, if (e.g., when) a user plane entity drops/discards an anchor PDU set, for example, instead of (e.g., rather than) sending a PDU set drop/discard message to the SMF. The user plane entity may send this to the other user plane entities transporting the stream.

The SMF may know the correlated streams carried in other QoS flows. The SMF may send the message to the user plane entities carrying these QoS flows. In addition to the SN of the lost anchor PDU set and the stream ID, the SMF may, for example, send the QoS flow ID, which may identify the QoS flow carrying the stream.

In examples, a fourth active discard option may include that the user plane entity may monitor the arrival of PDU sets. The user plane entity may track a duration (e.g., starts a timer), for example, based on the arrival of a first PDU set. The user plane entity may determine if a timing parameter (e.g., requirement) is met for this PDU set, for example, based on an arrival of a second PDU set. If not, the PDU set may be actively discarded. The user plane entity may determine the first PDU set and the second PDU set, for example, based on configuration. The user plane entity may be configured so that these are sequential PDU sets. The user plane entity may be configured so that these are two PDU sets that carry sequential I-frames. The PSA UPF may mark PDU sets (e.g., all PDU sets) that may (e.g., must) meet a timing parameter (e.g., requirement) with a PDU set Link ID. The user plane entity may determine the time difference between sequential PDU sets that have the same PDU set Link ID.

In examples, a fifth active discard option may include (e.g., for downlink traffic), the PSA UPF marking a (e.g., each) PDU set arriving over the interface (e.g., N6 interface) with the PDU set creation time. The PSA UPF may determine this information from information in the RTP Header Extension. Similarly (e.g., for uplink traffic), the WTRU may mark a (e.g., each) PDU set with the PDU set creation. The WTRU may mark the PDU set, for example, with the PDU set creation time. The user plane entity may be configured with an age requirement. The user plane entity may monitor the arrival of PDU sets. The user plane entity may determine the age of a PDU set (e.g., current time−PDU set creation time). If the determined age exceeds the age requirement, the user plane entity may actively discard the PDU set.

PDU Set Information Marking at PSA UPF and WTRU may be performed and/or described herein.

The PSA UPF may include in the PDU Set Information details that may assist correlation based PDU set active discarding.

The PSA UPF may mark the traffic incoming over the interface (e.g., N6 interface), for example, to support the various active discard options.

The PSA UPF may identify PDU sets from incoming DL traffic. This may be based on configuration information received from the SMF. The WTRU may include in the PDU Set information (e.g., part of the GTP-U header of the PDUs) one or more of the following: an anchor PDU Set indication (e.g., indication if this PDU set is an anchor PDU set); a PDU Set group ID (e.g., identifier of the PDU set group which contains the same anchor PDU set); an anchor PDU set SN (e.g., the sequence number of the PDU set which is the anchor PDU set for this PDU set); a PDU set link ID (e.g., one or more PDU sets that have a timing correlation are identified by the same PDU set link ID); a correlated PDU set (e.g., for a PDU set A, this may identify the PDU set to which PDU Set A is correlated to, for example, if Correlated PDU set is lost, PDU Set A may not be usable by the endpoint); the PDU set creation time; etc.

The WTRU may include in the PDU Set Information details, for example, to assist Correlation-based PDU set active discarding.

The WTRU may mark the traffic (e.g., to be sent over the air interface) to support the various active discard options.

The WTRU may identify PDU sets, for example, based on configuration information received from the SMF. The WTRU may include in the PDU Set information (part of the GTP-U header of the PDUs) one or more of the following: an anchor PDU set indication (e.g., indication if this PDU set is an anchor PDU set); a PDU Set group ID (e.g., identifier of the PDU set group which contains the same anchor PDU set); an anchor PDU set SN (e.g., the sequence number of the PDU set which is the anchor PDU set for this PDU set); a PDU set link ID (e.g., one or more PDU sets that have a timing correlation are identified by the same PDU set link ID); a correlated PDU set (e.g., for a PDU set A, this may identify the PDU set to which PDU Set A is correlated, and if the Correlated PDU set is lost, PDU Set A may not be usable by the endpoint).

AF Provisioning may be performed and/or described herein.

The AF may assist the network with correlation, for example, based on PDU set active discarding.

The AF may provision parameters to enable and assist the network to provide correlation-based PDU set active discarding. This may be useful to allow the AF some control over which streams allow correlation-based PDU set active discarding. For example, an AF may prefer that the network refrains from actively drop PDU sets. For some video streams, the decoders may be built to compensate for packet and video frame losses and with error concealment, but they may provide a significantly better user experience if the data is not discarded.

The AF may configure the network (e.g., 5G network) with the assistance information using an API (e.g., enhanced API). For example, a NEF service API (e.g., such as “Nnef_AFsessionWithQoS_Create”) may include (e.g., be enhanced to include) a CB-PSAD IE. The CB-PSAD IE may include one or more of the following: a stream ID (e.g., stream identifier to identify the stream on which the PDU sets will be carried); a CB-PSAD enabled/disabled indication; timing requirements; list of correlated stream IDs (e.g., if inter-stream correlation is enabled, the AS/AF may provide a list of stream IDs that are correlated to the current stream); maximum active discard percentage; age requirements for a stream that may indicate a maximum age of a PDU set; etc.

The CB-PSAD IE may include a CB-PSAD enabled/disabled indication. The CB-PSAD enabled/disabled indication may indicate whether the correlation based active discarding is enabled for the stream. If enabled, the AS/AF may provide the correlation based discarding that is allowed. Examples of correlation based discarding may include one or more of the following: intra-stream anchor PDU set based correlation, inter-stream flow anchor PDU set based correlation, intra-stream time-reference PDU set based correlation, inter-stream time-reference PDU set based correlation, PDU set drop/discard propagation, etc.

The CB-PSAD IE may include timing parameters (e.g., requirements). If time-reference correlation is enabled, the AS/AF may provide an indication of the timing parameters (e.g., requirements) that may (e.g., need to) be met for the stream. The timing parameter (e.g., requirement) may be in terms of a maximum timing delay, a range of acceptable timing delays, a maximum jitter, a range of acceptable jitters, etc. These timing measures may be between consecutive PDU sets. These timing measures may be between specific PDU sets. For example, the timing may be between two consecutive PDU sets carrying I-frames. The timing reference may be between the start of a first PDU set and the start of a second PDU set, the end of a first PDU set and the end of a second PDU set, or between the end of a first PDU set and the start of the second PDU set, or between the start of a first PDU set and the end of the second PDU set.

The CB-PSAD IE may include a (e.g., maximum) Active Discard Percentage. The AF may (e.g., want to) limit the amount of active discarding in the mobile network. It may provide a (e.g., maximum) percentage of PDU sets that may be discarded by the mobile network. The network may use this percentage to limit the user plane entities that perform active discards (e.g., by disabling active discard for these entities). The network may provide a discard percentage to each user plane entity. The user plane entity may refrain from exceeding (e.g., not exceed) this configured discard percentage. For example, the user plane entity may refrain from discarding PDU sets after a configured discard percentage has been met.

The CB-PSAD IE may include age requirements. The AS/AF may provide an indication of the maximum age requirements for the PDU sets of a stream. The user plane entities may be configured with the maximum age requirement for a stream. The user plane entity may determine the current age of the PDU set, for example, based on reception of a PDU set. The user plane entity may determine the age by subtracting the PDU set creation time from the current time. The PDU set creation time may be included as part of the PDU set information carried in the GTP-U header. The user plane entity may actively discard the PDU set, for example, if the age of the PDU set is greater than the configured maximum age requirement for the stream.

The AS/AF may (e.g., as an alternative to providing a List of Correlated Stream IDs per stream) provide a Correlated Stream label to (e.g., all) streams that are correlated. For example, the label may be a (e.g., unique) number that is shared by (e.g., all) streams that are correlated.

User Plane Entity configuration information (e.g., configuration) may be provided, enabled, and/or described herein.

The user plane entities may be configured to support correlation based PDU set active discarding.

The PCF may generate rules (e.g., PCC rules) and may provide them to a SMF. The SMF may determine the QoS profile(s) and may send these to the RAN node. The SMF may determine the QoS rules and may send these to the WTRU. The SMF may determine the rules (e.g., N4 rules) and may send these to the UPFs. The SMF may configure the user plane entities with configuration information related to correlation based PDU set active discarding. This configuration information may include one or more of the following: a CB-PSAD IE; information associated with sending PDU set drop/discard information (e.g., control plane, user plane); replace dropped PDU set indication; replace discarded PDU set indication.

The configuration information related to correlation based PDU set active discarding may include information associated with sending PDU set drop/discard information (e.g., control plane, user plane). If PDU set drop/discard propagation is enabled, the SMF may further configure the user plane entity with information as to where to send the PDU set drop/discard information (e.g., control plane, user plane). If control plane is selected, the user plane entity may send the Anchor PDU Set drop/discard indication to the SMF. If user plane is selected, the user plane entity may send the Anchor PDU Set drop/discard indication in a dummy PDU over the user plane.

The configuration information related to correlation based PDU set active discarding may include a replace dropped PDU set indication. The replace dropped PDU set indication may include an indication that configures the user plane entity to send a dummy PDU if (e.g., when) a PDU set is dropped. The dummy PDU may include the sequence number of the dropped PDU set and/or an indication that the PDU set has been dropped. This dummy PDU may allow the upstream user plane entities to continue to perform any sequence number processing.

The configuration information related to correlation based PDU set active discarding may include a replace discarded PDU set indication. The replace discarded PDU set indication may include an indication that configures the user plane entity to send a dummy PDU when a PDU set is discarded. The dummy PDU may include the sequence number of the discarded PDU sets, for example, as well as an indication that the PDU set has been discarded. This dummy PDU allows the upstream user plane entities to continue to perform a sequence number processing.

Actions may be performed at User Plane Entities. The actions performed at UPE(s) may be described herein.

Actions at user plane entities may be performed, for example, based on determining that a PDU set is dropped/discarded.

The user plane entity may discard (e.g., all) other PDU sets in the PDU set group, for example, if a user plane entity determines that a PDU set is dropped/discarded and the PDU set is an anchor PDU set in a PDU set group.

The user plane entity may save the PDU set SN and stream ID of a PDU set, for example, if a user plane entity determines that a PDU set is dropped/discarded and the PDU set is an anchor PDU set. The user plane entity may (e.g., subsequently) verify if the PDU sets have the anchor PDU set SN equal to the stored SN. If yes, the user plane entity may discard these PDU sets.

The user plane entity may send a dummy PDU to replace the missing PDU set, for example, if a PDU set is discarded or dropped. This may allow the upstream entities to know that a PDU set has been dropped/discarded. The dummy PDU may include the PDU set sequence number of the discarded PDU set and/or an indication of why the PDU set was discarded.

The user plane entity may send an indication to the SMF, for example, if a PDU set is discarded or dropped/discarded. This indication may include a PDU set drop IE, for example, which may include one or more of the following: PDU set group ID, the PDU set SN of the dropped/discarded PDU set, the stream ID, the QoS flow ID, etc.

The user plane entity may send an indication in a dummy PDU to other user plane entities, for example, if a PDU set is discarded or dropped. This indication may include a PDU set drop IE, for example, which may include one or more of the following: PDU set group ID, the PDU set SN of the dropped/discarded PDU set, the stream ID, and the QoS flow ID. This may be sent in the header of the GTP-U headers of the dummy PDU. The user plane entity may send the PDU Set drop IE in an RTCP message to the other user plane entities.

If a PDU set is dropped/discarded, the network may send a message to the Application Server to indicate that a PDU set has been dropped/discarded. This may be useful to the Application Server to suspend further processing of the group of pictures (GOP).

Actions at user plane entities may be based on receiving a PDU set drop/discard message.

A RAN node may be indicated to (e.g., told) that an upstream user plane entity may have dropped/discarded an Anchor PDU set. The RAN node may determine that some PDU sets may be discarded, for example, based on the PDU set drop/discard message.

A WTRU may be indicate (e.g., told) that an upstream user plane entity may have dropped/discarded an anchor PDU set. The WTRU may determine that some PDU sets may be discarded, for example, based on the PDU set drop/discard message. This may avoid using air interface resources as well as WTRU computing resources.

The RAN node may receive information about dropped/discarded PDU sets.

The RAN node may be aware of the PDU sets that it drops (e.g., due to congestion). The RAN node may not be aware of PDU sets that have been dropped by other entities in the network.

Another user plane entity may drop or discard a PDU set. In such a case, PDU set drop information may be provided to the RAN node.

In examples, the user plane entity may include the information in a dummy PDU or in a header of the user plane traffic. The information may be carried in the QoS flow to the RAN node.

In examples, the RAN node may receive the information from the SMF. The SMF may receive the information from the user plane entities using a session report (e.g., N4 Session Report). The SMF may receive the information from an Application Server.

In examples, the RAN node may receive the information from a WTRU.

The WTRU node may receive information about dropped/discarded PDU sets.

The WTRU may be aware of PDU sets that have failed transmission over the uplink (e.g., due to not meeting the PSDB). The WTRU may not be aware of PDU sets that have been dropped by other entities in the network.

Another user plane entity may drop a PDU set. In such a case, PDU set drop/discard information may be provided to the WTRU.

In examples, the user plane entity may include the information in a dummy PDU or in a header of the user plane traffic. The information may be carried in the QoS flow to the WTRU.

In examples, the WTRU may receive the information from the SMF. The SMF may receive the information from the user plane entities using a session report (e.g., N4 Session Report). The SMF may receive the information from an Application Server.

The SMF may send an SM message to the WTRU.

The SMF may send a message to the RAN node, which may send an RRC message to the WTRU, for example, including the PDU set drop/discard information.

In examples, the WTRU may determine the PDU set drop/discard information from the application.

Details associated with a PDU set drop/discard message may be described herein.

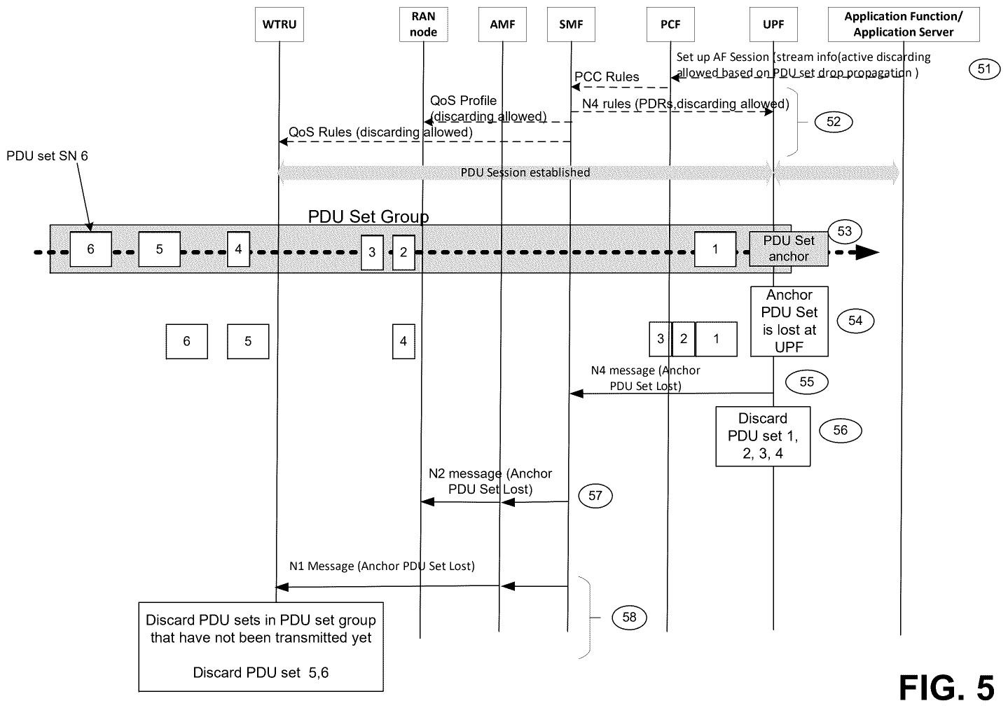

Active discarding may be based on the PDU Set drop/discard message received from the SMF. FIG. 5 illustrates an example of PDU Set drop/discard information propagated to WTRU.

As shown at 51 in FIG. 5, the AF may configure the network to enable active discarding based on PDU set drop/discard propagation.

As shown at 52 in FIG. 5, the SMF may configure the WTRU with QoS rules, the RAN node with QoS profile, and/or the UPF with rules (e.g., N4 rules). This configuration information may include the indication that PDU set drop/discard propagation is enabled.

The WTRU may create a PDU set group, for example, containing an anchor PDU set (e.g., initial PDU set) and a number of additional PDU sets (e.g., 6 additional PDU sets, for example, numbered 1-6).

As shown at 53 in FIG. 5, the Anchor PDU set and PDU set 1 may arrive (e.g., be received) at the UPF. PDU sets 2 and 3 may be at the RAN node. PDU sets 4, 5, 6 may be waiting for transmission on the uplink from the WTRU.

As shown at 54 in FIG. 5, the anchor PDU set may be dropped/discarded at the UPF, for example, due to congestion.

As shown at 55 in FIG. 5, the UPF may send a PDU set message to the SMF (e.g., N4 session message), for example, which may indicate the dropped/discarded anchor PDU session, the PDU session SN, and/or the stream ID.

As shown at 56 in FIG. 5, the PDU sets 1, 2, 3 may be at the UPF. These may be actively discarded by the UPF, for example, as the Anchor PDU set of the PDU set group has been dropped/discarded.

As shown at 57 in FIG. 5, the SMF may send the PDU set dropped/discarded message to the RAN.

As shown at 58 in FIG. 5, the SMF may send the PDU set dropped/discarded message to the WTRU. PDU sets 5 and 6 (e.g., of the PDU set group) may be waiting for transmission at the WTRU. The WTRU may decide to actively discard PDU sets 5 and 6, for example, as the anchor PDU set in the PDU set group has been dropped/discarded in the UPF.

A time-reference correlation may be considered. Active discarding based on time reference correlation may be described herein.

Active discarding may be based on time reference correlation, for example, where the timing may be between two sequential PDU sets. The network may decide to enable active discarding (e.g., only) at the RAN node and WTRU.

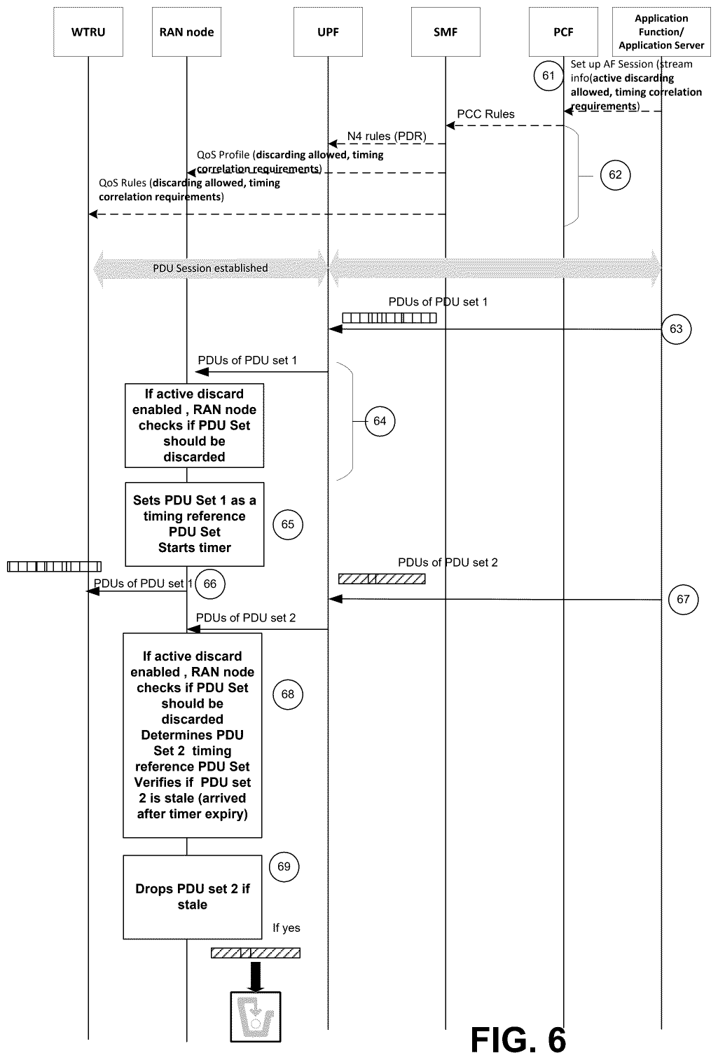

FIG. 6 illustrates an example of PDU set discarding based on timing correlation requirements.

As shown at 61 in FIG. 6, the AF may configure the network to enable active discarding based on time reference correlation. The AF may provide the timing parameter (e.g., requirement).

As shown at 62 in FIG. 6, the SMF may configure the WTRU with QoS rules, the RAN node with QoS profile, and/or the UPF with rules (e.g., N4 rules). This configuration information for the WTRU and RAN node may include the indication that time-reference correlation is enabled, and the timing correlation parameter (e.g., requirement).

As shown at 63 in FIG. 6, the UPF may receive PDU set 1. The UPF may refrain from monitoring timing for active discarding.

As shown at 64 in FIG. 6, the UPF may send the PDU set 1 to RAN node. The RAN node may check if a PDU may be discarded.

As shown at 65 in FIG. 6, the RAN node may determine that the PDU set 1 is a time reference PDU set, and may track a time (e.g., start a timer) based on the timing paramater or requirement (e.g., with respect to 62 in FIG. 6).

As shown at 66 in FIG. 6, the RAN node may send the PDU set 1 to WTRU (e.g., over multiple air interface transmissions).

As shown at 67 in FIG. 6, the UPF may receive PDU set 2.

As shown at 68 in FIG. 6, the UPF may send the PDU set 2 to a RAN node. The RAN node may determine that this PDU set has a timing reference. The RAN node may check if the PDU set is stale (e.g., if time tracked/started with respect to 65 in FIG. 6 may have expired).

As shown at 69 in FIG. 6, as the time may have expired, the RAN node may actively discard PDU set 2.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

What is claimed is:

1. A wireless transmit/receive unit (WTRU), the WTRU comprising:
a processor, wherein the processor is configured to:
receive a message from a network node, wherein the message indicates an active discarding/dropping indication, an active discarding option, a protocol data unit (PDU) set notification parameter, and a timing correlation parameter;
determine that a PDU set is a reference PDU set based on the timing correlation parameter;
determine an age of the PDU set when it is determined that the PDU set is the referenced PDU set; and
determine whether the PDU set is to be used or discarded based on at least one of the active discarding/dropping indication, the active discarding/dropping option, the age of the PDU set, or a propagated PDU set drop/discard information.

2. The WTRU of claim 1, wherein the WTRU is a first WTRU, wherein the network node is a first network node, and wherein the processor is further configured to receive the PDU set from a second WTRU or a second network node.

3. The WTRU of claim 1, wherein the processor is further configured to receive the propagated PDU set drop/discard information from the network node.

4. The WTRU of claim 1, wherein the referenced PDU set is a first referenced PDU set, and wherein the processor is further configured to determine a duration of time associated with the PDU set when it is determined that the PDU set is associated with a second referenced PDU set.

5. The WTRU of claim 1, wherein the processor is further configured to:
discard the PDU set when it is determined that the PDU set is to be discarded; and
send a notification message to a network entity based on a rule and the PDU set notification parameter, wherein the notification message indicates that the PDU set has been discarded.

6. The WTRU of claim 1, wherein the WTRU is a first WTRU, wherein the network node is a first network node, wherein the processor is further configured to:
send the PDU set to a second WTRU or a second network node when it is determined the PDU set is to be used.

7. The WTRU of claim 1, wherein the PDU set is associated with at least one of uplink data or downlink data.

8. The WTRU of claim 1, wherein the WTRU is a first WTRU, wherein the network node is a first network node, wherein the propagated PDU set drop/discard information is associated with one or more PDU sets that have been discarded or dropped by at least one of a second WTRU, the first network node, or a second network node.

9. A method performed by a wireless transmit/receive unit (WTRU), the method comprising:
receiving a message from a network node, wherein the message indicates an active discarding/dropping indication, an active discarding option, a protocol data unit (PDU) set notification parameter, and a timing correlation parameter;
determining that a PDU set is a reference PDU set based on the timing correlation parameter;
determining an age of the PDU set when it is determined that the PDU set is the referenced PDU set; and
determining whether the PDU set is to be used or discarded based on at least one of the active discarding/dropping indication, the active discarding/dropping option, the age of the PDU set, or a propagated PDU set drop/discard information.

10. The method of claim 9, wherein the WTRU is a first WTRU, wherein the network node is a first network node, and wherein the processor is further configured to receive the PDU set from a second WTRU or a second network node.

11. The method of claim 9, wherein the processor is further configured to receive the propagated PDU set drop/discard information from the network node.

12. The method of claim 9, wherein the referenced PDU set is a first referenced PDU set, and wherein the method further comprises determining a duration of time associated with the PDU set when it is determined that the PDU set is associated with a second referenced PDU set.

13. The method of claim 9, wherein the method further comprises:
discarding the PDU set when it is determined that the PDU set is to be discarded; and
sending a notification message to a network entity based on a rule and the PDU set notification parameter, wherein the notification message indicates that the PDU set has been discarded.

14. The method of claim 9, wherein the WTRU is a first WTRU, wherein the network node is a first network node, wherein the method further comprises:
sending the PDU set to a second WTRU or a second network node when it is determined the PDU set is to be used.

15. The method of claim 9, wherein the PDU set is associated with at least one of uplink data or downlink data.

16. The method of claim 9, wherein the WTRU is a first WTRU, wherein the network node is a first network node, wherein the propagated PDU set drop/discard information is associated with one or more PDU sets that have been discarded or dropped by at least one of a second WTRU, the first network node, or a second network node.

17. A first network node, the first network node comprising:
a processor, wherein the processor is configured to:
receive a first message from a second network node, wherein the first message indicates a configuration associated with a session level report;
receive a session level report based on the configuration associated with the session level report, wherein the session level report indicates information indicating a discarded protocol data unit (PDU) set;
determine a wireless transmit/receive unit (WTRU) or a third network node impacted by the discarded PDU set based on the configuration and the session level report; and
send a second message to the WTRU or the third network node, wherein the second message indicates information indicating the discarded PDU set.

18. The first network node of claim 17, wherein the WTRU is a first WTRU, and wherein the processor being configured to determine the session level report comprises the processor being configured to receive the session level report from at least one of the first WTRU, a second WTRU, the second network node, the third network node, or a fourth network node.

19. The first network node of claim 17, wherein the session level report comprises at least one of an information element, an identification of a user plane element (UPE), or an identification of the discarded PDU set.

20. The first network node of claim 17, wherein the second message comprises an information element.
